(19) United States
(12) Patent Application Publication
(10) Pub. No.: US 2026/0048918 A1
(43) Pub. Date: Feb. 19, 2026

(54) RE-CLOSABLE CONTAINER WITH ZIPPER

(71) Applicant: Reckitt Benckiser Finish B.V., Hoofddorp (NL)

(72) Inventors: Miriam Katherina ALLGAIER, Heidelberg (DE); Malgorzata HERMAN, Nowy Dwór Mazowiecki (PL); Krzysztof Jerzy KRAJEWSKI, Schiphol (NL)

(21) Appl. No.: 19/103,004

(22) PCT Filed: Aug. 10, 2023
(86) PCT No.: PCT/EP2023/072150

§ 371 Date: Feb. 11, 2025

(30) Foreign Application Priority Data
Aug. 18, 2022 (GB) 2212054.7

(51) Int. Cl. B65D 75/58; B23K 26/402; B23K 103/00; B31B 70/00; B65D 30/08; B65D 33/25; B65D 65/42; B65D 75/00; B65D 75/26

(52) U.S. Cl. CPC B65D 75/5805; B31B 70/25; B65D 31/02; B65D 33/25; B65D 65/42; B65D 75/008; B65D 75/26; B23K 26/402; B23K 2103/40; B23K 2103/42; B65D 2565/385; B65D 2575/586

(57) ABSTRACT

A re-closable container 1 comprises a container body 5 having an opening at an upper end for receiving and retrieving at least part of a content of the container body 5 and a zipper 3 for selectively closing and releasing the opening. The zipper 3 has a zipper line 11 along which the zipper extends from a first side 13 to a second side 15 of the container body 5. A notch 17 is arranged underneath the zipper line 11 and at the first 13 or/and at the second side 15 of the container body 5, wherein the notch 17 is configured to remove the zipper 3 by tearing off the zipper 3 from the container body 5 along a tearing line 19.

The present disclosure relates to a re-closable container with zipper.

Re-closable containers are very popular, because they can be used multiple times and keep the content safe from environmental influences. In particular, re-closable pouches with zipper enjoy widespread use and include, e.g., food or detergents. The zipper is usually made of plastic of a certain type.

The pouches can be made of several materials, including laminates containing plastic or paper-based laminates.

When the content of the pouch has been used up, the pouch should be made available for recycling.

In case of paper-based laminates forming the container body of the pouch, the total plastic content of the pouch is still about 15%, because of the plastic content in the laminate such as a coating—and not including the zipper. The latter adds about a further 10% to the total plastic amount of the pouch, arriving at a total plastic content of about 25%.

Certain countries currently allow for a maximum of 15% plastic content for a paper-based pouch to be recyclable in the national paper waste recycling stream.

Even if the pouch is not paper-based, it can be made of a material different from the zipper material such that both should not be fed to the same (plastic) recycling stream.

It is therefore an object of the invention to provide for a re-closable container with zipper having better recyclability.

This object is achieved by a re-closable container with zipper which comprises a container body having an opening at an upper end for receiving and retrieving at least part of a content of the container body and a zipper for selectively closing and releasing the opening, wherein the zipper has a zipper line along which the zipper extends from a first side to a second side of the container body. A notch is arranged underneath the zipper line and at the first or/and at the second side of the container body, and the notch is configured to remove the zipper by tearing off the zipper from the container along a tearing line, the tearing line extending from the first to the second side of the container body.

The invention enables removing the (plastic) zipper from the re-closable container without the need of additional tools such as scissors. It is simply torn off by applying a tearing force at the notch, and the tearing force then propagates further along a tearing line, from one side of the pouch to the other. The zipper can then be recycled or discarded, separate from the container body.

In a first preferred embodiment, the notch is a blunt pencil cut, or it has a rectangular shape, or the notch is a punching out.

The inventors have found out that the shape of the notch will determine the force necessary to initiate the tearing off process. Therefore, choosing a suitable shape of the notch will protect the container against accidentally ripping apart the container body along the tearing line. A “blunt pencil cut” shall describe a cut (incision) resembling the tip of a pencil which has been in use for a while, exhibiting a semi-circular or semi-elliptical tip shape. A “punching out” shall describe an area of the re-closable container at the left and/or the right side of the container where container material has been cut out. Such punching out may be located at a distance from the left and/or right side of the container such that tearing off the zipper along the tearing line via the punching out will first need to overcome the resistance of the container material over said distance before the punching out (=area of removed container material) is reached and the tearing off will propagate with less effort. Preferably, the distance is between 0.5 and 3 mm. The initial tearing force depends on said distance.

By contrast, a different shape of the notch such as a sharp pencil cut, will require a smaller force to initiate the tearing off process, as compared to the blunt pencil cut. A “sharp pencil cut” shall describe a cut (incision) resembling the tip of a pencil which has been newly sharpened, exhibiting a triangular, sharp tip shape.

In a second preferred embodiment, the tearing line includes laser scoring for supporting propagation of the tearing off along the tearing line. In such embodiment, laser scoring describes a line of micro perforations created e.g., by a laser. It helps e.g., to avoid removing too much of the container body material by providing for a defined tearing line. As an alternative, said micro perforations can also be executed by means other than a laser, such as mechanical cuts.

In a third embodiment, the container is sealed above the zipper line, and the container further comprises a further notch arranged above the zipper line, wherein the further notch is arranged at the first or/and at the second side of the container body. The further notch is configured to open the sealed container by tearing off the upper end from the container body along a further tearing line. Before first use, a re-closable container typically comes in a sealed state. In this embodiment, the container includes two tearing off features: A first for opening the sealed container by tearing off the upper end of the container along the further tearing line, and a second for tearing off the zipper along the tearing line. Tearing off the upper end of the container gives access to the zipper such that the container can be re-used in the following while its content has not been used up. After the content has been used up, the zipper can be torn off and the container body be recycled, separate from the zipper.

In a fourth embodiment, the further notch is:
a sharp pencil cut,
a slit, or
a combination of a sharp pencil cut with a slit.

As stated earlier, the shape of the notch and further notch will determine the respective initial force necessary for initiating the tearing off process. A sharp pencil cut will allow for a small force necessary to tear off the upper end of the container, providing for a convenient container opening experience for the consumer and not requiring an additional tool such as scissors.

In such embodiment, the shape of the notch foreseen for tearing off the zipper after the content of the container has been used up is typically chosen to provide for a bigger force necessary for initiating tearing off the zipper as compared to tearing off the upper end. As stated earlier, the notch (for tearing off the zipper) can e.g., be embodied as a blunt pencil cut or it can have a rectangular shape.

In a fifth embodiment, the further tearing line includes laser scoring for supporting propagation of the tearing off along the further tearing line. In such embodiment, again, laser scoring describes a line of micro perforations created by e.g., a laser. As an alternative, said micro perforations can also be executed by means other than a laser, such as mechanical cuts. It helps e.g., to avoid removing too much of the container body material (and prevents damaging e.g., the zipper) by providing for a defined further tearing line. In a preferred embodiment, the laser scoring of the tearing line includes at least one line of laser scoring, and the laser scoring of the further tearing line includes more lines of laser scoring than the tearing line. In particular, the tearing line includes at least one line of laser scoring, preferably one line of laser scoring, and the further tearing line includes at least two adjacent, parallel lines of laser scoring. The more lines of laser scoring are provided, the easier the tearing off process will propagate along the tearing line respectively further tearing line. This means that choosing an appropriate amount of parallel, adjacent tearing (respectively further tearing) lines as well as e.g., the distance between the micro perforations, will determine the ease with which the respective component (such as the upper end and/or the zipper) can be torn off. Typically, it shall be more convenient to tear off the upper end (i.e., opening the container and obtaining access to the zipper) than tearing off the zipper—to avoid an unwanted ripping off the container underneath the zipper line while the content of the container is not yet used up and the zipper is still needed to open and close the container.

In a sixth embodiment, a first force necessary for initiating the tearing off of the zipper along the tearing line is bigger than a second force necessary for initiating the tearing off of the upper end along the further tearing line, this can be achieved by deliberately selecting the respective shape of the notch and further notch. In particular, the ratio of the first force to the second force is between 1.5 and 3, preferably between 2 and 3, and most preferably 2. As stated before, it shall be harder to tear off the zipper after use up than to tear off the upper end of the container when opening the container.

In a seventh embodiment, the container is made of a laminate including plastic, wherein the total plastic content of the container, excluding the zipper, is at most 15%, In particular, the container body is made of a paper-based laminate. In this embodiment, the container provides for good recyclability, e.g., in the paper waste stream. In another embodiment, the paper-based laminate includes a coating, wherein the coating can determine the strength or material resistance of the container body. The strength or material resistance of the container body determines how easy—or hard—it is to rip the container. As the present invention foresees for a deliberate ripping of the container, in order to tear off the upper end (for access to the content via the zipper) respectively the zipper (after use up), the strength or material resistance of the container body must be well-balanced. On the one hand side, it must not be too strong to impair the deliberate tearing open and/or removing the zipper, and on the other side it must not be too weak, to avoid unwanted ripping. In conjunction with the notch and/or the further notch—which determine the initial force necessary to start the tearing off process (by lowering the initial force, as compared with a container body not having the notch or further notch), a good balance can be achieved between those different objectives.

In a preferred embodiment, the container is a re-closable bag with zipper such as a pouch, a stand up pouch, or a doy pack.

In an eight embodiment, the container includes a front side and a rear side which are sealed together at the first and second side in a respective sealing region having a sealing width, and the further notch is wider than the notch. When the notch is not as wide as the further notch, tearing off the zipper will be harder than tearing the container open. For example, in such instance, more of the sealing width (which constitutes a more resilient, thicker material) has to be overcome when tearing off the zipper than when tearing the container open.

In the following, the present invention is illustrated with reference to the Figures:

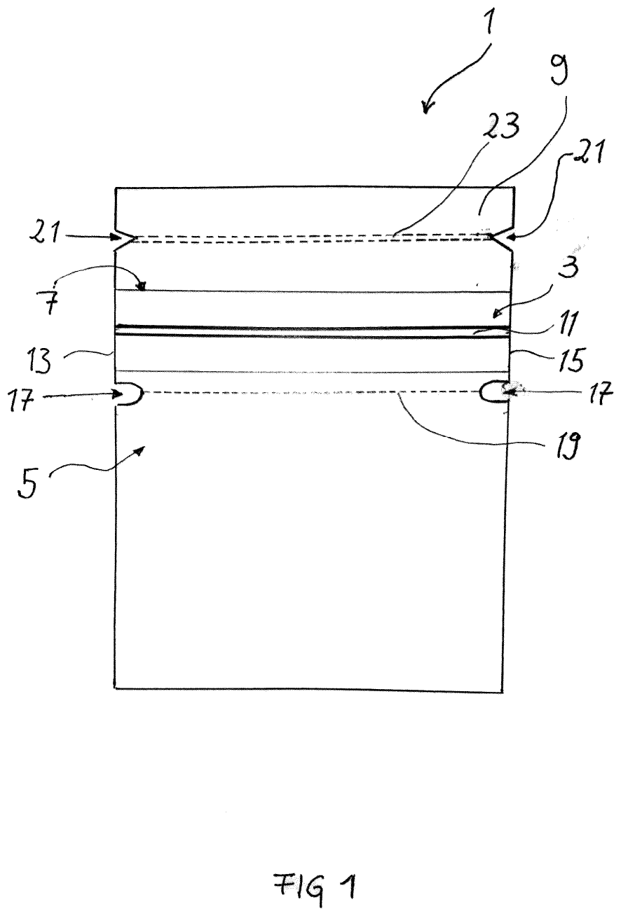

FIG. 1 shows a schematic illustration of a re-closable container with zipper according to the invention, embodied as a stand-up pouch.

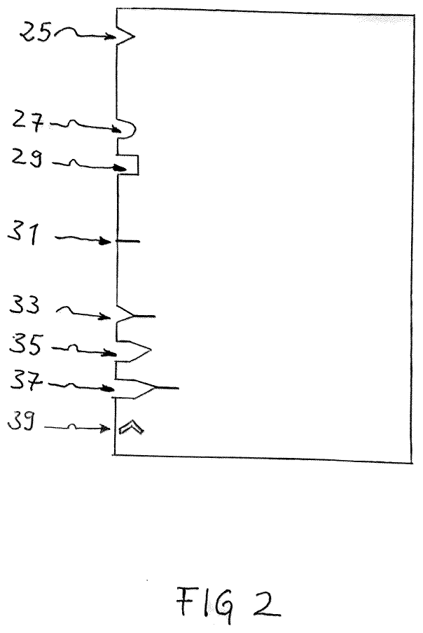

FIG. 2 illustrates various shapes suitable as embodiments for the notches.

In FIG. 1, the re-closable container 1 is shown from a frontal view when the stand-up pouch (embodying the container 1) is in a standing position.

The pouch 1 (e.g., a doy pack) includes a zipper 3 such that it can selectively be opened and closed. At an upper part 9, typically right at the top of the pouch, it is sealed before first use. The pouch 1 can be made of a plastic-based laminate, but is preferably made of a paper-based laminate. The zipper 3 typically includes matching zipper profiles attached to the interior of the front and rear side of the pouch and is made of plastic.

When a consumer wants to open the sealed pouch 1, he/she can leverage the further notch 21 by applying a tearing force to the upper part 9, at the location of the further notch 21, such that the pouch will go open, with the tearing process propagating along the further tearing line 23, from a first side 13 to a second side 15 of the pouch. The zipper 3 will then be accessible such that a content of the pouch 1 can be (partially) retrieved and the pouch re-closed, and the torn-off piece of the upper part 9 can be discarded. The tearing line 23 preferably includes laser scoring, i.e., micro perforations along the tearing line 23, to support tearing off propagation along a defined line. As an alternative, said micro perforations can also be executed by means other than a laser, such as mechanical cuts.

Sooner or later, the content of the pouch will be used up and the pouch is ready for recycling.

In many instances, the zipper 3 is not suitable for recycling together with the pouch body 5. E.g., the pouch body 5 can comprise a paper-based laminate—which is suitable for recycling in a paper waste recycling stream but must not contain more than 15% of non-paper material. The zipper 3, which is typically made of plastic, leads to an overall higher plastic content of the pouch 1. In order for the pouch 1 to still be eligible for paper recycling in such case, the zipper 3 must be removed.

To accomplish this in a convenient manner and without the need of additional tools such as scissors, the zipper 3 can be separated from the pouch body 5 and discarded (or recycled) separately: The pouch body 5 includes a notch 17 at which a consumer can apply a tearing force, to tear off the zipper 3 from the pouch body, with the tearing off process propagating along a tearing line 19.

The initial force necessary to initiate the tearing off process is different for tearing open the pouch via the further notch 21 versus the initial force necessary to initiate the tearing off process for removing the zipper 3 via the notch 17. The shape of the notch 17 respectively further notch 21 substantially determines the size of the initial force necessary for initiating the respective tearing off process.

Typically, opening the sealed pouch 1 via the further notch 21 should be easier than removing the zipper 3 (after use up) via the notch 17, to avoid an unwanted ripping of the pouch 1 at the notch 17 before the content of the pouch is used up. To that end, in the embodiment of the Figure, the notch 17 is a blunt pencil cut whereas the further notch 21 is a sharp pencil cut.

It will be appreciated that further embodiments of the respective notch shape will be possible serving the same aim of arriving at a higher initial force necessary for tearing off the zipper 3 than opening the pouch 1.

In FIG. 1, both notches 17 respectively 21 are arranged symmetrically, i.e., at both sides 13 and 15 of the pouch 1. This will allow for maximum flexibility for the consumer as to the side from which he wants to open the pouch 1, or remove the zipper 3. He/she e.g., does not need to flip around the pouch 1 to achieve a preferred orientation.

In principle, however, one notch 17 and one further notch 21 arranged at either the first 13 (e.g., left) or the second (e.g., right) side 15 would be sufficient.

It is e.g., possible to arrange the notch 21 (only) on the left side of the pouch 1 and the notch 17 (only) on the right side of the pouch. Intuitively, right-handed persons tend to tear from left to right. Arranging the notch 17 (only) on the right side of the pouch can thus better avoid that the pouch 1 is ripped via the notch 17 accidentally, before the content is used up.

For left-handed person, flipping around the pouch 1 will yield the same improvement.

Furthermore, in the embodiment of FIG. 1, the tearing off line 19 as well as the further tearing off line 23 include laser scoring, i.e. micro perforations at dedicated distances along the respective tearing off line. The further tearing off line 23 in the example of the Figure includes two adjacent lines of laser scoring, whereas the tearing off line 19 only includes one line of laser scoring. This will further facilitate an easier tear-off of an upper part 9 (to open the sealed pouch 1) as compared to the tear-off of the zipper 3. Also, the presence of laser scoring will achieve a defined line, along which the tear-off propagates. This can e.g., avoid the removal of too much material (which could then be lost for recycling), and/or it can prevent the zipper from being damaged by the tear-off of (part of) the upper part when opening the sealed pouch 1.

The pouch 1 and in particular the notches 17 and 21 are designed such that a first force necessary for initiating the tearing off of the zipper 3 along the tearing line 19 is bigger than a second force necessary for initiating the tearing off of the upper end 9 along the further tearing line 23. The ratio of the first and second forces is between 1.5 and 3, preferably between 2 and 3, and most preferably 2.

It will be appreciated that the pouch material properties will basically define the ease of tear through the material in all conditions. The material will need to be strong itself and will require an additional structural element to open (such as a notch), but not too strong in order to maximize consumer experience but e.g., also provide for child safety. Paper materials in relation to plastic are much easier to tear; however, the amount of a coating and type of coating, and the paper itself will play a role in defining the inherent material resistance.

It is proven that the notch geometry (shape) plays a direct role in tear initiation.

FIG. 2 shows various shapes which are suitable to be used for the notch 17 and/or notch 21 in the embodiment of FIG. 1.

The first example is a sharp pencil cut 25, which has been referred to earlier.

The second example is a blunt pencil cut 27, which also has been referred to earlier.

The third example employs a rectangular shape 29 and can be regarded as a variation of the blunt pencil cut 27.

The fourth example is a slit 31. The slit 31 can vary in length.

The fifth example is a combination 33 of the sharp pencil cut 25 with the slit 31.

The sixth example can be regarded as a combination 35 of the variation of the blunt pencil cut 29 having a rectangular shape with the sharp pencil cut 25. In this embodiment, the variation of the blunt pencil cut 29 serves as a lead-in to the sharp pencil cut 25.

The seventh example is a combination 37 of the combination 35 with the slit 31.

The eight example is a punching out 39. It can have any shape and e.g. be triangular, circular, rectangular, linear or combinations thereof. The punching out 39 can be arranged at a distance from the left and/or right side of the container. Said distance determines the magnitude of the initial tearing force: The greater the distance, the more container material needs to be overcome by the tearing off process and the harder tear initiation is. Preferred distances are between 0.5 and 3 mm.

Suitable combinations of notches 17 and 21 are e.g.:
Notch 21 embodied as any of 25, 31, 33, 35 and 37.
Notch 17 embodied as any of 27, 29 and 39.

It is noted that any embodiment of the notches 17 and 21 can also include a slit. The embodiments 33 and 37 are purely exemplary and not-limiting. In particular, also any embodiment of the notch 17 can include a slit, such as a combination of the blunt pencil cut 27 or the variation of the blunt pencil cut 29 with a slit 31, or the punching out 39 with a slit 31.

The present invention can be summarised as follows:

A re-closable container 1 comprises a container body 5 having an opening at an upper end 9 for receiving and retrieving at least part of a content of the container body 5 and a zipper 3 for selectively closing and releasing the opening. The zipper 3 has a zipper line 11 along which the zipper extends from a first side 13 to a second side 15 of the container body 5. A notch 17 is arranged underneath the zipper line 11 and at the first 13 or/and at the second side 15 of the container body 5, wherein the notch 17 is configured to remove the zipper 3 by tearing off the zipper 3 from the container body 5 along a tearing line 19.

In a preferred embodiment the container 1 is sealed at the upper end 9 and above the zipper line 11, and the container 1 further comprises a further notch 21 arranged above the zipper line 11 such that the sealed container 1 can be opened by tearing off the upper end 9 from the container body 5 along a further tearing line 23.

Hence one or more objects of the present invention are achieved by the present re-closable container with zipper which is further elucidated in the appended claims.

1. A re-closable container with zipper, comprising:
a container body having an opening at an upper end for receiving and retrieving at least part of a content of the container body; and
a zipper for selectively closing and releasing the opening, the zipper having a zipper line along which the zipper extends from a first side to a second side of the container body;
and
a notch arranged underneath the zipper line and at the first or/and at the second side of the container body, the notch configured to remove the zipper by tearing off the zipper from the container body along a tearing line), the tearing line extending from the first to the second side of the container body.

2. The re-closable container according to claim 1, wherein the notch is a blunt pencil cut, or wherein the notch has a rectangular shape, or wherein the notch is a punching out.

3. The re-closable container according to claim 1, wherein the tearing line includes laser scoring for supporting propagation of the tearing off along the tearing line.

4. The re-closable container according to claim 1, wherein
the container is sealed at the upper end and above the zipper line,
the container further comprises a further notch arranged above the zipper line,
the further notch arranged at the first or/and at the second side of the container body, and
the further notch is configured to open the sealed container by tearing off the upper end from the container body along a further tearing line, the further tearing line extending from the first to the second side of the container body.

5. The re-closable container according to claim 4, wherein the further notch is a sharp pencil cut, a slit, a combination of a sharp pencil cut with a slit, a combination of a rectangular shape with a sharp pencil cut or a combination of a rectangular shape with a sharp pencil cut and a slit.

6. The re-closable container according to claim 4, wherein the further tearing line includes laser scoring for supporting propagation of the tearing off along the further tearing line.

7. The re-closable container according to claim 3, wherein the laser scoring of the tearing line includes at least one line of laser scoring, and the laser scoring of the further tearing line includes more lines of laser scoring than the tearing line.

8. The re-closable container according to claim 7, wherein the tearing line includes at least one line of laser scoring, and the further tearing line includes at least two adjacent, parallel lines of laser scoring.

9. The re-closable container according to claim 4, wherein the notch and the further notch are configured such that a first force necessary for initiating the tearing off of the zipper along the tearing line is bigger than a second force necessary for initiating the tearing off of the upper end along the further tearing line.

10. The re-closable container according to claim 9, wherein the ratio of the first force to the second force is between 1.5 and 3.

11. The re-closable container according to claim 1, wherein the container is made of a laminate including plastic, wherein the total plastic content of the container, excluding the zipper (3), is at most 15%.

12. The re-closable container according to claim 1, wherein the container body is made of a paper-based laminate.

13. The re-closable container according to claim 11, wherein the laminate includes a coating, wherein the coating determines the material resistance of the container body.

14. The re-closable container according to claim 1, wherein the container is a pouch, a stand up pouch or a doy pack.

15. The re-closable container according to claim 4, wherein
the container includes a front side and a rear side which are sealed together at the first and second side in a respective sealing region having a sealing width, and
the further notch is wider than the notch, and
wherein the container is a pouch, a stand up pouch or a doy pack.

16. The re-closable container according to claim 9, wherein the ratio of the first force to the second force is between 2 and 3.

17. The re-closable container according to claim 9, wherein the ratio of the first force to the second force is 2.
